(19) United States
(12) Patent Application Publication
(10) Pub. No.: US 2005/0097690 A1
(43) Pub. Date: May 12, 2005

(54) Cleaning apparatus for rotary and orbitally mounted buffing pads

(76) Inventor: Richard A. Kaiser, Town of Merton, WI (US)

Correspondence Address: Joseph J. Jochman;ANDRUS, SCEALES, STARKE & SAWALL, LLP, Suite 1100, 100 East Wisconsin Avenue, Milwaukee, WI, 53202-4178, US

(21) Appl. No.: 10/704,042

(22) Filed: Nov. 7, 2003

(51) Int. Cl. B08B 1/00

(52) U.S. Cl. 15/104.92; 15/3; 15/21.1

(57) ABSTRACT

An apparatus for cleaning the buffing face of a power driven buffing pad while mounted on a buffing machine includes separate cleaning devices adapting the apparatus to clean both rotary driven pads and orbitally driven pads. The cleaning deck, enclosed within a container for the cleaning solution, carries the optional removable pad cleaning devices and is vertically adjustable with a simple adjustment arrangement on the inside container wall to accommodate pads of varying thickness.

### BACKGROUND OF THE INVENTION

The present invention relates to an apparatus for cleaning buffing pads of the type mounted on and driven by a powered buffing machine and, more particularly, to a cleaning apparatus for pads used on either a rotary or orbitally driven buffing machine.

The apparatus described and claimed herein constitutes an improvement on the apparatus shown in my prior U.S. Pat. Nos. 4,786,333; 4,983,221; 5,471,726 and 5,682,638, the disclosures of which are incorporated by reference herein. Each of the apparatus disclosed in the foregoing patents included a container that comprised a reservoir for a cleaning solution, a deck that included cleaning wheels and against which a buffing pad mounted on a rotary powered buffing machine was placed. Operation of the rotary buffing machine caused the cleaning wheels to turn to help loosen wax, polish, dirt and the like embedded in the face of the buffing pad. Means were also provided for delivering cleaning solution to the pad in engagement with the deck, including an electrically driven pump, a pump driven by the rotating buffing pad, and a water wheel also driven by the rotating buffing pad.

All of the foregoing apparatus provide very effective means for cleaning rotary power driven buffing pads. However, orbitally driven buffing pads have also come into common use and, because of the manner in which orbital motion is delivered to the face of the buffing pad, it has been found that prior art rotary buffing pad cleaning devices do not clean orbital buffing pads very well. Orbitally mounted buffing pads are not driven to rotate, but rather rotate intermittently and indiscriminately as a result of the orbital motion imparted to them. In particular, there is no rotary motion in an orbitally mounted pad to effectively drive the small cleaning wheels characteristic of the apparatus described in the above identified patents.

In addition, my U.S. Pat. No. 5,682,638 discloses a height adjustment mechanism for the cleaning deck of a pad cleaning apparatus so that pads of varying thickness may be cleaned in the apparatus while permitting a pivotal cover to be closed to retain cleaning solution within the container during the cleaning operation. The height adjustment mechanism, however, required individual adjustment of each of three deck-supporting legs. This adjustment was time consuming and somewhat awkward for the operator.

### SUMMARY OF THE INVENTION

In accordance with the present invention, a pad cleaning apparatus includes a cleaning deck whose vertical position within the container may be easily adjusted to accommodate pads of different thickness. In addition, the deck includes pad cleaning devices effective to clean either a rotary driven buffing pad or an orbitally driven buffing pad, the cleaning device or the latter being demountable from the deck when not needed. The apparatus also includes a unitary cleaning solution pumping device mounted in a vertical tubular recess in the wall of the reservoir.

The apparatus of the present invention is especially adapted for cleaning the buffing face of a power driven buffing pad while the pad is mounted on the power buffing machine. The apparatus comprises a reservoir for a liquid cleaning solution, the reservoir having an outer wall with a peripheral upper edge that defines an open upper end. A generally horizontal deck is supported within the reservoir for vertical adjustment on supports that are formed integrally with the inside wall of the reservoir. Pad cleaning devices are supported on the deck for engaging and cleaning the buffing face of a pad when the pad is positioned within the open upper end of the reservoir.

The reservoir is generally circular in horizontal cross section and the deck supports preferably comprise vertically and circumferentially spaced shoulders, and the deck includes a peripheral outer edge having radially extending lugs that are sized to engage and rest upon selected shoulders. The selected support shoulders may comprise a plurality of groups of vertical support ribs, each group defining a plurality of coplanar horizontal shoulders. The support ribs of each group are equally spaced circumferentially around the inside wall of the reservoir. In a preferred embodiment, the support ribs are bounded by vertical guide ribs that are spaced horizontally apart by a distance slightly larger than the circumferential width of the lugs on the deck. In the preferred embodiment, the inside wall of the reservoir includes a peripheral horizontal ledge below the support ribs that defines a lowermost deck support surface. The support ribs may have lower ends that terminate at the horizontal ledge.

The pad cleaning devices on the deck comprise a plurality of cleaning wheels rotatably attached to the deck and positioned to contact the buffing face of the pad. Preferably, the pad cleaning devices include at least one cleaning brush having bristles positioned to contact the buffing face of the pad. The cleaning brush is preferably carried on a demountable insert. The cleaning wheels comprise coaxially mounted wheel sets that are carried on a cleaning wheel insert, and the deck is provided with a cleaning wheel recess for receipt of the cleaning wheel insert. Preferably, the apparatus includes a pair of cleaning wheel inserts, each of which carries a set of axially spaced cleaning wheels on common rotational axis extending generally radially with respect to the buffing face of the pad, the wheels of one set being offset radially on the rotational axis with respect to the wheels of the other set.

The pad cleaning apparatus also includes a pump device that has a liquid inlet near the bottom of the container and a liquid distribution nozzle adjacent the underside of the deck. An opening in the deck is aligned with the liquid distribution nozzle to permit liquid cleaning solution pumped from the level below the deck to impinge on the buffing face of the pad. The pump device preferably comprises a unitary assembly of a tubular pump housing containing the liquid inlet, and impeller, an outlet to the distribution nozzle, a motor, a battery and a switch. The reservoir includes a tubular recess in and extending vertically along the reservoir outer wall, the recess sized to receive the pump housing therein. The apparatus preferably includes a removable cover plate that is supported on the upper edge of the reservoir. The cover plate has an integral pump housing cover that is aligned with the tubular recess and covers the upper end of the pump housing when the cover plate is in place.

### BRIEF DESCRIPTION OF THE DRAWINGS

The drawings illustrate the best mode presently contemplated of carrying out the invention.

In the drawings:

FIG. 1 is an exploded perspective view of the apparatus of the present invention with a portion cutaway to show interior details.

FIG. 2 is a vertical section through the assembled apparatus of the present invention.

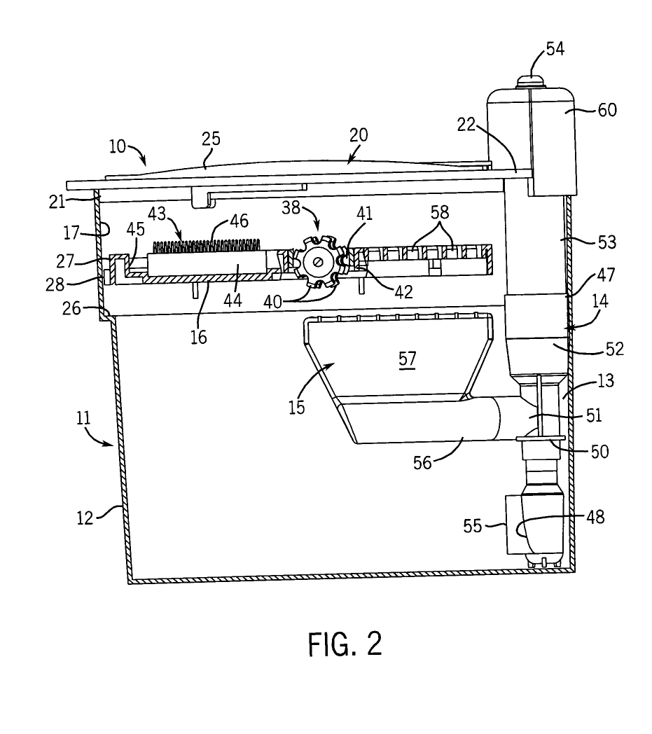

### DETAILED DESCRIPTION OF THE PREFERRED EMBODIMENT

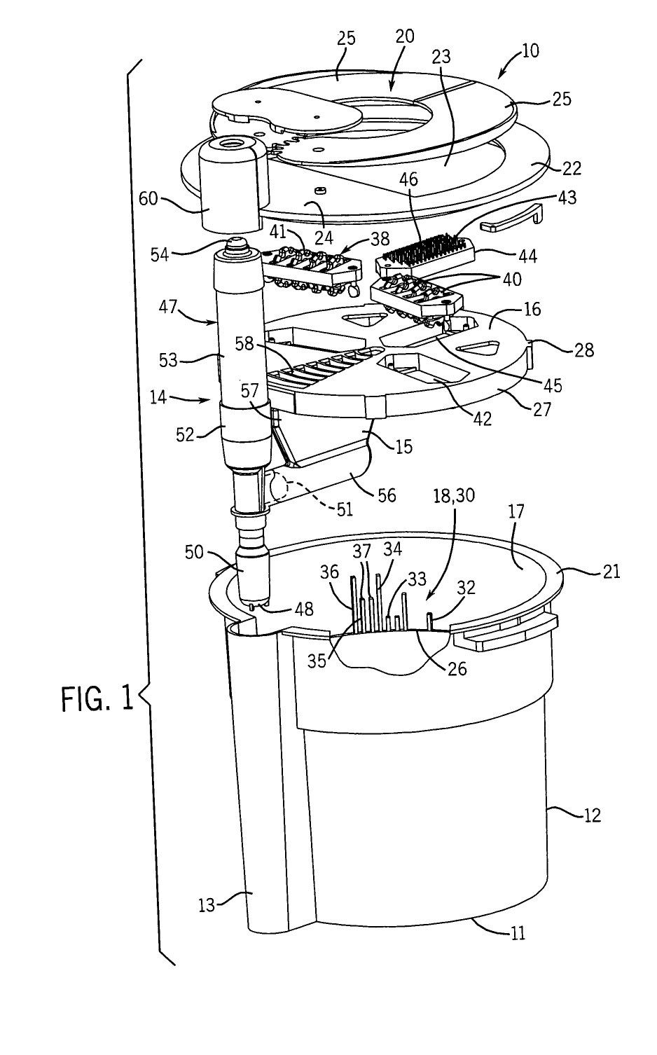

A pad cleaning apparatus 10 of the present invention is shown in the exploded view of FIG. 1 where its major component parts may be seen. The apparatus 10 is housed in and includes a large container 11 which serves as a reservoir for a liquid cleaning solution and also supports the remainder of the pad cleaning apparatus. The container 11 is generally cylindrical in shape with the outer wall 12 having a slight taper or draft for molding purposes, as is well known in the art. The outer wall 12 of the container 11 includes an integral tubular recess 13 that runs the full length of the outer wall 12 and opens to the interior of the container. Tubular recess houses a pump device 14 which delivers the liquid cleaning solution from the lower part of the container 11 to a discharge nozzle 15. The discharge nozzle is positioned below a cleaning deck 16 which is supported on the inside wall 17 of the container 11 for adjustable vertical positioning on supports 18 on the inside wall 17, which supports are integrally molded with the container 11. The container 11 is closed by a cover plate assembly 20 that rests on the upper rim 21 of the container 11. The space between the top of the deck 16 and the cover plate assembly 20 is adapted to receive a buffing pad mounted on a power driven buffing machine such that powered contact of the buffing pad with cleaning devices on the surface of the deck 16 helps loosen and remove buffing and similar compounds and dirt from the working face of the pad, assisted by a spray of cleaning liquid from the discharge nozzle 15 through openings in the deck. The cover plate assembly 20 includes a main outer rim 22 that defines a large truncated circular opening 23 large enough to receive a conventional buffing pad mounted on a backing plate and attached to and driven by a buffing machine. The widened portion 24 of the outer rim 22 has pivotally mounted thereon the ends of a pair of semi-circular cover members 25 which can be pivoted from an open position permitting insertion of a buffing pad and attached backing plate through the semi-circular opening 23 and a closed position surrounding the drive shaft of the buffing machine and enclosing the buffing pad and backing plate within the container 11. The foregoing construction is generally known in the art and the unique features of the pad cleaning apparatus of the present invention will be described below.

As indicated above, the cleaning deck 16 is adjustably mounted inside the container 11 using a simple, but very effective, arrangement of supports 18 on the inside wall 17 of the container. In the preferred embodiment shown, the container 11 has a stepped wall that defines, on the inside wall 17, an annular horizontal ledge 26. The cleaning deck 16 comprises a generally horizontal disk having a circular peripheral outer edge 27 from which a number of circumferentially spaced radially extending lugs 28 extend. The lugs 28 engage the horizontal ledge 26 on the inside wall of the container to support the cleaning deck 16 in its lowermost position within the container. As best seen in FIG. 1, extending vertically upwardly from the horizontal ledge 26 are a plurality of circumferentially spaced groups of vertical support ribs 30 positioned between vertically extending guide ribs 31. The groups of support and guide ribs are spaced circumferentially around the inside wall 17 of the container to align with one of the lugs 28 on the edge of the deck 16. In the embodiment shown, the deck has four lugs 28, spaced at 90 degree intervals around the circumference of the container, and four groups of support and guide ribs 30, 31 similarly spaced. For the lowermost position of the cleaning deck 16, in which the lugs 28 rest directly on the annular horizontal ledge 26, the lugs are confined between a first pair of guide ribs 32 which engage the sides of the lugs 28 to prevent rotary movement of the deck plate inside the container. A first pair of vertical support ribs 33 is positioned between one of the vertical guide ribs 32 and a longer vertical guide rib 34. The tops of the first pair of support ribs 33 are flat and horizontal to engage and support one of the lugs 28 on the deck as the lugs are permitted to slide between the guide rib 32 and longer guide rib 34. Similarly, an adjacent second pair of support ribs 35 is positioned between longer vertical guide rib 34 and an outer guide rib 36 of the same length. The second pair of support ribs 35 also has flat upper support surfaces 37. Thus, by raising or lowering the deck plate and turning it on its vertical axis, the plate may be moved to be supported within the container in any one of three vertical positions defined by the horizontal ledge 26, the first pair of support ribs 33 and the second pair of support ribs 35. In each of these positions, the enclosing guide ribs retain the deck against rotation in the container.

The upper surface of the cleaning deck 16 is provided with two types of pad cleaning devices, one of which is particularly adapted to clean the face of a rotary driven buffing pad and the other of which is more suitable to cleaning the buffing face of an orbitally driven pad. Two sets 38 of cleaning wheels 40 are mounted on the deck 16. Each set includes a plurality of coaxially mounted wheels 40 carried on a cleaning wheel insert 41. The inserts 41 are received in a cleaning wheel recess 42 in the deck and held therein by attachment screws (not shown) from the underside of the deck. Cleaning wheel inserts, when installed, are flush with the upper surface of the deck, but the cleaning wheels 40 project above the horizontal surface of the deck, such that they are engaged by the face of the buffing pad and driven by rotation of the pad over the deck. As is known in the prior art, the cleaning wheels 40 have a toothed configuration such that their rotation against the rotatably driven buffing pad helps to loosen caked wax, dirt, and other materials from the face of the pad. As is also known, each set 38 of cleaning wheels is mounted on a common rotational axis with the axis extending generally radially with respect to the deck and the face of the buffing pad. As is also known, the wheels of one set may be offset radially on its rotational axis with respect to the wheels of the other set, thereby assuring cleaning wheel contact with nearly the entire face of the pad as it rotates over the wheels.

With an orbitally driven pad, the orbital driver imparts an eccentric orbital motion to the pad, but the pad is rotationally free-wheeling. It has been found that an orbitally driven pad does not rotate effectively over the deck and the cleaning wheels 40 and, therefore, is not as easily cleaned in prior art devices designed for rotary driven pads. Therefore, the improved apparatus of the present invention includes a cleaning brush 43 mounted on a cleaning brush insert 44 which, in turn, is demountably seated in a cleaning brush recess 45 in the upper surface of the deck 16. The brush insert 44 may be attached to the deck from below with screws, similarly to the cleaning wheel inserts 41. The bristles 46 of the cleaning brush 43 extend upwardly from the surface of the deck and engage the soiled surface of the orbitally driven buffing pad in contact therewith. The driven orbital and free-wheeling rotary action of the pad promotes effective loosening of dirt and caked wax from the pad surface and, along with the liquid cleaning device to be described, promotes very effective cleaning of an orbitally driven pad. The cleaning brush 43 is not particularly suitable for cleaning a rotary driven buffing pad, so the cleaning brush insert 44 is preferably removed when rotary pads are being cleaned. On the other hand, cleaning wheel inserts 41 may be left in place for cleaning either type of pad.

As indicated in the general description above, a pump device 14 is carried in the tubular recess 13 formed in the wall 12 of the container. The pump device is completely self contained in a tubular pump housing 47 and includes, beginning at the lower end, a liquid inlet 48, an impellar 50, an outlet 51, an electric motor 52, a battery 53 and a switch 54. A filter screen 55 is preferably attached to the liquid inlet 48. The discharge nozzle 15 is attached to the pump outlet 51 and includes a supply pipe 56 which may be conveniently slipped over the outlet 51 and a fan shaped outlet nozzle 57 positioned directly below the underside of the deck 16. The deck is provided with an arrangement of open inlet slots 58 directly above the outlet nozzle 57. Thus, with the pump motor operating, liquid cleaning solution is directed upwardly through the inlet slots 58 in the deck to impinge directly on the soiled surface of the buffing pad operating against the cleaning devices on the upper surface of the deck.

The upper rim 21 of the cover plate assembly 20 includes an integral pump housing cover 60 which covers the upper end of the pump housing 47, except for a small hole at the top through which the push-button switch 54 projects.

Certain variations of the above-described preferred embodiment may be utilized. For example, instead of utilizing screws or other threaded fasteners to hold the cleaning wheel inserts 41 and the cleaning brush insert 44 on the deck, an arrangement could be utilized in which drop-in inserts are pushed down into the respective recesses and then radially outwardly under detents in the deck which hold the inserts in place. With respect to the deck supports 18 on the inside wall of the container, pairs of vertical support ribs 33 and 35 could be replaced with a single wide rib. Also, the vertical guide ribs 31 could be eliminated and modified deck lugs 28 could be provided with recesses on the underside to receive the upper ends of the support ribs 30 to provide lateral engagement, as well as vertical support.

1. An apparatus for cleaning a power driven buffing pad having a buffing face while the pad is mounted on a buffing machine, said apparatus comprising:
a reservoir for a liquid cleaning solution, said reservoir including an outer wall having a peripheral upper edge defining an open upper end;
a generally horizontal deck supported within the reservoir for vertical adjustment on supports formed integrally with an inside wall of the reservoir; and
pad cleaning devices supported on the deck for engaging and cleaning the buffing face of a pad when the pad is positioned within the open upper end of the reservoir.

2. The apparatus as set forth in claim 1 wherein said reservoir is generally circular in horizontal cross section and said supports comprise vertically and circumferentially spaced shoulders, and said deck includes a peripheral outer edge having radially extending lugs sized to engage and rest upon selected shoulders.

3. The apparatus as set forth in claim 2 wherein said selected support shoulders comprise a plurality of groups of vertical support ribs, each group defining a plurality of coplanar horizontal shoulders.

4. The apparatus as set forth in claim 3 wherein the vertical support ribs of each group are equally spaced circumferentially around the inside wall of the reservoir.

5. The apparatus as set forth in claim 3 wherein the support ribs are bounded by vertical guide ribs spaced horizontally apart by a distance slightly larger than the circumferential width of the lugs on said deck.

6. The apparatus as set forth in claim 3 wherein the inside wall of the reservoir includes an annular peripheral horizontal ledge below said support ribs defining a lowermost deck support surface.

7. The apparatus as set forth in claim 6 wherein said support ribs have lower ends that terminate at said horizontal ledge.

8. The apparatus as set forth in claim 1 wherein said pad cleaning devices comprise a plurality of cleaning wheels rotatably attached to the deck and positioned to contact the buffing face of the pad.

9. The apparatus as set forth in claim 1 wherein said pad cleaning devices comprise at least one cleaning brush having bristles positioned to contact the buffing face of the pad.

10. The apparatus as set forth in claim 9 wherein said cleaning brush is demountable.

11. The apparatus as set forth in claim 8 wherein said cleaning wheels comprise coaxially mounted wheel sets carried on a cleaning wheel insert, and a cleaning wheel recess in the deck for receipt of said cleaning wheel insert.

12. The apparatus as set forth in claim 11 including a pair of cleaning wheel inserts, each carrying a set of axially spaced cleaning wheels on a common rotational axis extending generally radially with respect to the buffing face of the pad, the wheels of one set being offset radially on the rotational axis with respect to the wheels of the other set.

13. The apparatus as set forth in claim 1 wherein the reservoir is adapted to carry a volume of said liquid cleaning solution at a level below the deck, and further comprising a pump device having a liquid inlet near the bottom of the container and a liquid distribution nozzle adjacent the underside of the deck, and an opening in the deck aligned with the liquid distribution nozzle to permit the liquid cleaning solution to impinge on the buffing face of the pad.

14. The apparatus as set forth in claim 13 wherein said pump device comprises a tubular pump housing containing the liquid inlet, an impeller, an outlet to said distribution nozzle, a battery and a switch; and wherein said reservoir includes a tubular recess in and extending vertically along the reservoir outer wall, said recess sized to receive said pump housing therein.

15. The apparatus as set forth in claim 14 including a removable cover plate supported on the upper edge of the reservoir, said cover plate having an integral pump housing cover aligned with said tubular recess and covering the upper end of the pump housing.
